(19) United States
(12) Patent Application Publication
(10) Pub. No.: US 2024/0214835 A1
(43) Pub. Date: Jun. 27, 2024

(54) MODEM PERFORMANCE OPTIMIZATION UNDER HIGH FREQUENCY DRIFT

(71) Applicant: QUALCOMM Incorporated, San Diego, CA (US)

(72) Inventors: Paolo MINERO, La Jolla, CA (US); Ravinder KUMAR, San Diego, CA (US); Tae Min KIM, San Diego, CA (US); Levent AYDIN, San Diego, CA (US)

(21) Appl. No.: 18/390,334

(22) Filed: Dec. 20, 2023

Related U.S. Application Data
(60) Provisional application No. 63/477,023, filed on Dec. 23, 2022.

(51) Int. Cl. H04W 24/02

(52) U.S. Cl. CPC H04W 24/02

(57) ABSTRACT

Methods, systems, and devices for wireless communications are described. A user equipment may identify a frequency drift condition that affects user equipment (UE) performance and may operate in modes of operation to optimize UE performance under frequency drift conditions. For example, the UE may estimate the rate of change of frequency error at the modem based on pilot signals, and if the change exceeds a threshold, the UE may enter into a frequency error response configuration to optimize performance under the high frequency error condition. The frequency error response configuration may involve an adjustment to channel state information feedback, an adjustment to a periodicity of synchronization signal block (SSB) or tracking reference signal (TRS) monitoring, use of an updated set of parameters for demodulation reference signal (DMRS) channel estimation, or use of an updated set of parameters for frequency tracking.

### CROSS REFERENCE

The present Application for Patent claims the benefit of U.S. Provisional Patent Application No. 63/477,023 by MINERO et al., entitled “MODEM PERFORMANCE OPTIMIZATION UNDER HIGH FREQUENCY DRIFT,” filed Dec. 23, 2022, assigned to the assignee hereof, and expressly incorporated by reference herein.

### FIELD OF TECHNOLOGY

The present disclosure relates to wireless communications, including modem performance optimization under high frequency drift.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support modem performance optimization under high frequency drift. For example, the described techniques provide for identifying a frequency drift condition that affects user equipment (UE) performance and modes of operation at the UE to optimize UE performance under frequency drift conditions. For example, the UE may estimate the rate of change of frequency error at the modem based on pilot signals, and if the change exceeds a threshold, the UE may enter into a frequency error response configuration to optimize performance under the high frequency error condition. The frequency error response configuration may involve an adjustment to channel state information (CSI) feedback reporting, an adjustment to a periodicity of synchronization signal block (SSB) or tracking reference signal (TRS) monitoring, use of an updated set of parameters for demodulation reference signal (DMRS) channel estimation, or use of an updated set of parameters for frequency tracking.

A method for wireless communications at a UE is described. The method may include identifying frequency drift at the UE exceeds a threshold and operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

An apparatus for wireless communications at a UE is described. The apparatus may include a processor, memory coupled with the processor, and instructions stored in the memory. The instructions may be executable by the processor to cause the apparatus to identify frequency drift at the UE exceeds a threshold and operate in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

Another apparatus for wireless communications at a UE is described. The apparatus may include means for identifying frequency drift at the UE exceeds a threshold and means for operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

A non-transitory computer-readable medium storing code for wireless communications at a UE is described. The code may include instructions executable by a processor to identify frequency drift at the UE exceeds a threshold and operate in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

In some examples of the method, apparatuses, and non-transitory computer-readable medium described herein, identifying the frequency drift at the UE exceeds the threshold may include operations, features, means, or instructions for identifying that the frequency drift output by a local oscillator of the UE exceeds the threshold.

In some examples of the method, apparatuses, and non-transitory computer-readable medium described herein, the threshold may be based on one of a periodicity of synchronization signals blocks received at the UE or a periodicity of tracking reference signals received at the UE.

In some examples of the method, apparatuses, and non-transitory computer-readable medium described herein, identifying the frequency drift at the UE exceeds the threshold may include operations, features, means, or instructions for determining a change in frequency error between a first time and a second time and filtering the change in frequency error between the first time and the second time to determine an instantaneous frequency drift, where the frequency drift may be the instantaneous frequency drift.

In some examples of the method, apparatuses, and non-transitory computer-readable medium described herein, operating in accordance with the frequency error response configuration may include operations, features, means, or instructions for operating in accordance with the frequency error response configuration including the adjustment to CSI feedback, where the adjustment to CSI feedback includes indicating a reduction in a data rate supported by the UE based on the frequency drift at the UE exceeding the threshold.

In some examples of the method, apparatuses, and non-transitory computer-readable medium described herein, the reduction in the data rate supported by the UE may be based on a time offset between reception of a CSI reference signal and one of a SSB or a tracking reference signal.

Some examples of the method, apparatuses, and non-transitory computer-readable medium described herein may further include operations, features, means, or instructions for receiving a grant indicating a scheduled data rate for a message based on the reduction in the data rate supported by the UE and monitoring for the message based on the grant.

In some examples of the method, apparatuses, and non-transitory computer-readable medium described herein, operating in accordance with the frequency error response configuration may include operations, features, means, or instructions for operating in accordance with the frequency error response configuration including the adjustment to the periodicity of SSB or TRS monitoring, where the adjustment to the periodicity of SSB or TRS monitoring includes an increase in the periodicity of SSB or TRS monitoring.

In some examples of the method, apparatuses, and non-transitory computer-readable medium described herein, operating in accordance with the frequency error response configuration may include operations, features, means, or instructions for operating in accordance with the frequency error response configuration including use of the updated set of parameters for DMRS channel estimation, the updated set of parameters for DMRS channel estimation including at least one of a correction factor associated with a noise estimate to account for inter-carrier interference or a quasi co-location (QCL) parameter and time-domain interpolation filter to account for frequency error.

In some examples of the method, apparatuses, and non-transitory computer-readable medium described herein, operating in accordance with the frequency error response configuration may include operations, features, means, or instructions for operating in accordance with the frequency error response configuration including use of the updated set of parameters for frequency tracking, the updated set of parameters for frequency tracking including at least one of a time-domain filter for estimating residual frequency error or an adjustment to tracking loop gain.

### BRIEF DESCRIPTION OF THE DRAWINGS

FIG. 1 illustrates an example of a wireless communications system that supports modem performance optimization under high frequency drift in accordance with one or more aspects of the present disclosure.

FIG. 2 illustrates an example of a wireless communications system that supports modem performance optimization under high frequency drift in accordance with one or more aspects of the present disclosure.

FIG. 3 illustrates an example of a frequency drift detection scheme that supports modem performance optimization under high frequency drift in accordance with one or more aspects of the present disclosure.

FIG. 4 illustrates an example of a timing diagram that supports modem performance optimization under high frequency drift in accordance with one or more aspects of the present disclosure.

FIGS. 5 and 6 illustrate block diagrams of devices that support modem performance optimization under high frequency drift in accordance with one or more aspects of the present disclosure.

FIG. 7 illustrates a block diagram of a communications manager that supports modem performance optimization under high frequency drift in accordance with one or more aspects of the present disclosure.

FIG. 8 illustrates a diagram of a system including a device that supports modem performance optimization under high frequency drift in accordance with one or more aspects of the present disclosure.

FIGS. 9 through 13 illustrate flowcharts showing methods that support modem performance optimization under high frequency drift in accordance with one or more aspects of the present disclosure.

### DETAILED DESCRIPTION

Increase in temperature at the modem of a user equipment (UE) may cause variations in the output frequency of the local oscillator of the UE. For example, as larger number of carriers are activated for a UE, the internal temperature of the UE modem may increase, which may cause variations in the output frequency of the local oscillator of the UE. Such variations in the output frequency can cause frequency drift. The UE may monitor frequency drift using a frequency tracking loop based on reception of pilot signals such as synchronization signal blocks (SSBs) or tracking reference signals (TRSs), and may correct for detected frequency drift. If the frequency drift is large, however, such as under high temperature conditions, the UE may not be able to sufficiently correct for the frequency drift, especially when pilot signals are received with a large periodicity, which may result in performance loss at the physical layer. For example, block error rate (BLER) of transmissions involving the UE may increase due to frequency drift, which may result in lowering of the physical layer throughput.

The present disclosure relates to techniques to identify a frequency drift condition that affects UE performance and modes of operation to optimize UE performance under frequency drift conditions. For example, the UE may estimate the rate of change of frequency error at the modem based on pilot signals, and if the change exceeds a threshold, the UE may enter into a frequency error response configuration to optimize performance under the high frequency error condition. The threshold may be based on a periodicity of the pilot signals (e.g., the SSBs or TRSs), which may be referred to as the loop update interval, as more frequency error may accumulate with a larger pilot signal periodicity. The frequency error response configuration may involve an adjustment to channel state information (CSI) feedback (e.g., a change in channel quality index (CQI)), an adjustment to a periodicity of SSB or TRS monitoring, use of an updated set of parameters for demodulation reference signal (DMRS) channel estimation, or use of an updated set of parameters for frequency tracking. For example, the CQI may indicate a lower channel quality as the UE may not be able to sustain high data rates with a large frequency error, and accordingly the network may schedule communications with the UE using a lower data rate (e.g., using a more conservative modulation and coding scheme (MCS)). As another example, the UE may increase the periodicity of SSB monitoring and/or TRS monitoring to better track and correct for frequency error. As another example, the UE may use a correction factor for noise when performing DMRS channel estimation to account for inter carrier interference caused by the frequency error. As another example, the UE may tune a time-domain filter for estimating for residual error when performing frequency tracking.

Aspects of the disclosure are initially described in the context of wireless communications systems. Aspects of the disclosure are further illustrated by and described with reference to frequency drift detection schemes and timing diagrams. Aspects of the disclosure are further illustrated by and described with reference to apparatus diagrams, system diagrams, and flowcharts that relate to modem performance optimization under high frequency drift.

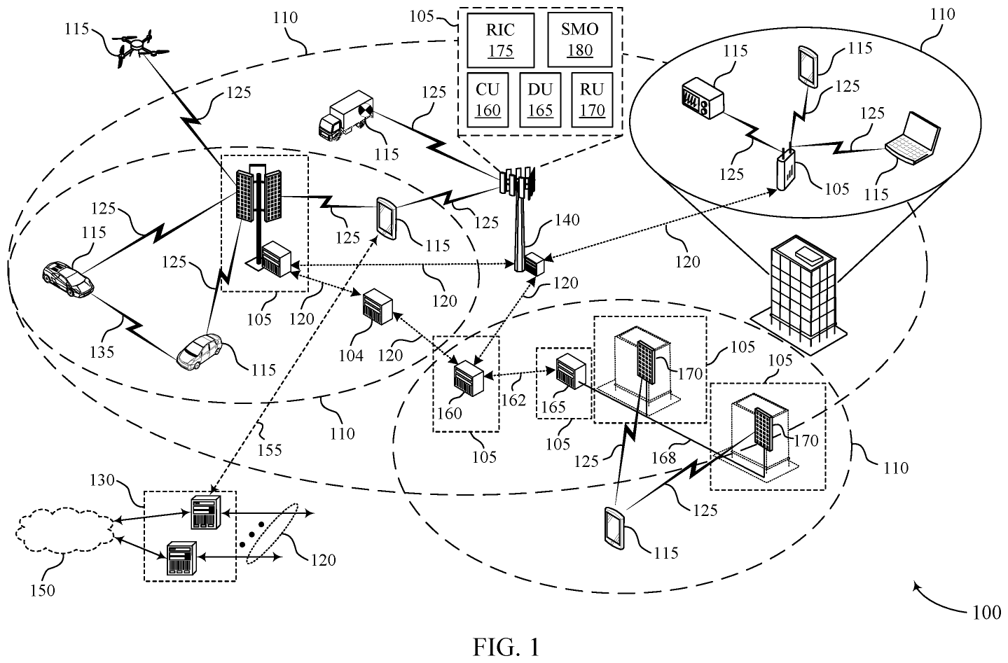

FIG. 1 illustrates an example of a wireless communications system 100 that supports modem performance optimization under high frequency drift in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support modem performance optimization under high frequency drift as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Increase in temperature at the modem of a UE 115 may cause variations in the output frequency of the local oscillator of the UE 115. For example, as larger number of carriers are activated for a UE 115, the internal temperature of the UE 115 modem may increase, which may cause variations in the output frequency of the local oscillator of the UE 115. Such variations in the output frequency can cause frequency drift at the UE 115. Additionally, some UEs may have higher temperature gradients than other UEs 115, which may result in larger variations in output frequency. A UE 115 may monitor frequency drift using a frequency tracking loop based on reception of pilot signals such as SSBs or TRSs, and may correct for detected frequency drift. If the frequency drift is large, however, such as under high temperature conditions, the UE 115 may not be able to sufficiently correct for the frequency drift, which may result in performance loss at the physical layer. For example, BLER of transmissions involving the UE 115 may increase due to frequency drift, which may result in lowering of the physical layer throughput.

Accordingly, a UE 115 may identify a frequency drift condition that affects UE 115 performance and the UE 115 may operate in modes of operation (e.g., a frequency error response configuration) that optimize UE 115 performance under frequency drift conditions. For example, the UE 115 may estimate the rate of change of frequency error at the modem based on pilot signals, and if the change exceeds a threshold, the UE 115 may enter into a frequency error response configuration to optimize performance under the high frequency error condition. The threshold may be based on a periodicity of the pilot signals (e.g., the SSBs or TRSs), which may be referred to as the loop update interval, as more frequency error may accumulate with a larger pilot signal periodicity. The frequency error response configuration may involve an adjustment to CSI feedback, an adjustment to a periodicity of SSB or TRS monitoring, use of an updated set of parameters for DMRS channel estimation, or use of an updated set of parameters for frequency tracking. For example, the CQI in a CSI feedback report may indicate a lower channel quality as the UE 115 may not be able to sustain high data rates with a large frequency error, and accordingly the network may schedule communications with the UE 115 using a lower data rate (e.g., using a more conservative MCS). As another example, the UE 115 may increase the periodicity of SSB or TRS monitoring to better track and correct for frequency error. As another example, the UE 115 may use a correction factor for noise when performing DMRS channel estimation to account for inter carrier interference caused by the frequency error. As another example, the UE 115 may tune a time-domain filter for estimating residual error when performing frequency tracking.

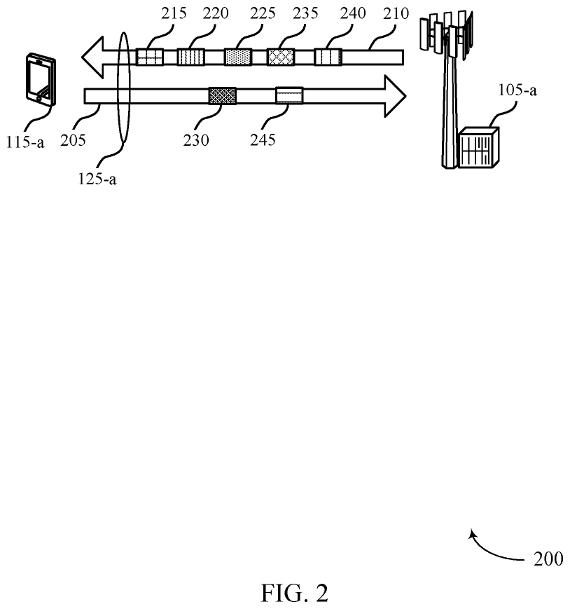

FIG. 2 illustrates an example of a wireless communications system 200 that supports modem performance optimization under high frequency drift in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 also includes a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a.

The UE 115-a may monitor for and receive TRSs 215 and/or SSBs 220 transmitted by the network entity 105-a. The UE may use the TRSs 215 and/or the SSBs 220 as pilot signals to estimate the rate of change of frequency error at the modem of the UE 115 and/or to correct for frequency error at the modem of the UE 115-a. Additionally, or alternatively, the UE 115-a may receive one or more CSI reference signals (CSI-RSs) 225 transmitted by the network entity 105-a, which the UE 115-a may use to estimate the channel between the UE 115-a and the network entity 105-a. The UE 115-a may transmit a CSI report 230 to the network entity 105-a based on the received CSI-RS(s). The CSI report 230 may include a CQI report (e.g., an indication of a CQI determined at the UE 115-a based on the received CSI-RS(s)).

As described herein, increases in the temperature of the modem of the UE 115-a may cause variations in the output frequency of the local oscillator of the UE 115-a. Such variations in the output frequency can cause frequency drift. Such frequency drift may degrade performance at the physical layer. For example, frequency drift may result in errors in uplink signals 205 and/or reception of downlink signals 210.

Accordingly, if the detected frequency change exceeds a threshold, the UE 115-a may enter into a frequency error response configuration to optimize performance under the high frequency error condition. The threshold may be based on a periodicity of the pilot signals (e.g., the SSB 220 or TRS 215), which may be referred to as the loop update interval as more frequency error may accumulate with a larger pilot signal periodicity, as the frequency error has more time to build before the UE 115-a can correct for the frequency error using the pilot signal received from the network entity 105-a. The frequency error response configuration may involve an adjustment to CSI feedback, an adjustment to a periodicity of SSB or TRS monitoring, use of an updated set of parameters for DMRS channel estimation, or use of an updated set of parameters for frequency tracking. The frequency error response configuration may enable the UE 115-a to reduce error caused by the frequency drift (e.g., use of the frequency error response configuration may reduce BLER and accordingly the UE 115-a may not observe a throughput loss under frequency drift conditions).

For example, the CQI in the CSI report 230 may indicate a lower channel quality as the UE 115-a may not be able to sustain high data rates with a large frequency error, and accordingly the network may schedule communications with the UE 115-a using a lower data rate (e.g., using a more conservative MCS). For example, the network entity 105-a may transmit a grant 235 scheduling a downlink transmission 240 or an uplink transmission 245. The grant 235 may indicate a lower data rate based on the CSI report 230 indicating the UE 115-a can support a reduced data rate due to the frequency drift. The UE 115-a may then monitor for the scheduled downlink transmission 240 or may transmit the scheduled uplink transmission 245 using the indicated data rate in the grant. The adjustment based on channel state feedback reporting may depend on the offset between (the time between reception of) the CSI-RS 225 and the pilot signal (the TRS 215 or SSB 220). For example, the larger the gap, the larger the correction (e.g., the larger the change in data rate in the frequency error response configuration).

As another example, the UE 115-a may increase the periodicity of monitoring for SSBs 220 and/or TRSs 215 to better track and correct for frequency error.

As another example, the UE 115-a may use one or more updated parameters for DMRS estimation, such as a correction factor for noise to account for inter carrier interference caused by the frequency error or a quasi co-location (QCL) parameter and time-domain interpolation filter to account for frequency error. For example, downlink signals 210 may include DMRSs, and the UE 115-a may use the DMRSs to perform channel estimation. In a frequency response configuration, the UE 115-a may use a correction factor for noise and/or the signal to noise ratio (SNR) when performing DMRS channel estimation to account for inter carrier interference caused by the frequency error. For example, the correction factor may be a unitless scaling factor to reduce the expected SNR (or other noise estimate). Additionally, or alternatively, in some examples, the UE 115-a may use additional QCL parameter to account for the frequency error when performing DMRS channel estimation. Example QCL parameters may be Doppler shift and/or Doppler spread (both in Hz), which may be used to reflect the frequency error by use of a more conservative QCL parameter. The UE 115-a may additionally or alternatively tune the filter order coefficients used for time domain channel interpolation to reflect the larger residual frequency error when performing DMRS channel estimation. As another example, the UE 115-a may tune a time-domain filter for estimating residual error when performing frequency tracking. As another example, the UE 115-a may use an updated set of parameters for frequency tracking, such as an updated tracking loop gain.

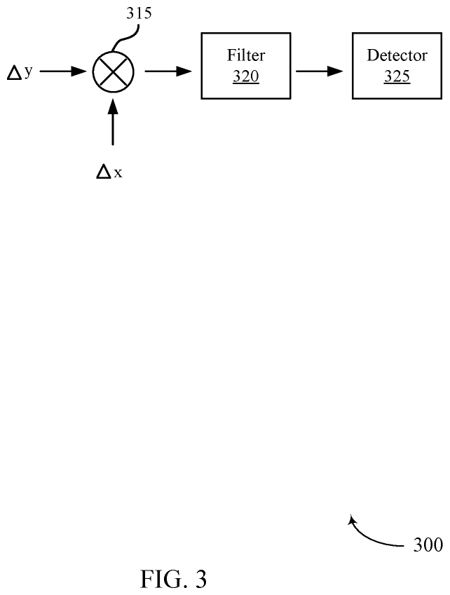

FIG. 3 illustrates an example of a frequency drift detection scheme 300 that supports modem performance optimization under high frequency drift in accordance with one or more aspects of the present disclosure. The frequency drift detection scheme 300 may implement aspects of or may be implemented by aspects of the wireless communications system 100. For example, the frequency drift detection scheme 300 may be implemented by a UE 115 as described herein.

As described herein, a UE 115 may detect frequency error at the modem of the UE 115 due to high temperature drift. The UE 115 may estimate the rate of change of the frequency error at the modem, for example, using the frequency drift detection scheme 300. If the rate of change of the frequency error at the modem is found to be changing at a rate larger than a threshold, then the UE 115 may enter a frequency error response configuration as described herein to accommodate the frequency error.

At 315, the UE 115 computes the change in total frequency error Δy=(y₂−y₁) between a first time x₁ and a second time x₂ (e.g., Δx=(x₂−x₁). At 315 the UE 115 computes the instantaneous frequency drift as Δy/Δx. At 320, the UE 115 may filter the instantaneous frequency drift, for example using an infinite impulse filter. At 325, the UE 115 may detect whether the filtered instantaneous frequency drift exceeds a threshold, where the threshold may be a function of a periodicity of the pilot signal (e.g., the SSB or TRS periodicity). The periodicity T of the pilot signal may be input to the detector at 325. For example, the frequency error detection scheme may determine the total amount of frequency drift (error) between pilot signals, as (Δy/Δx)*T. At 325, if the filtered instantaneous frequency drift exceeds the threshold, the UE 115 identifies the modem has a high frequency drift condition, and the UE 115 may accordingly enter a frequency error response configuration as described herein to accommodate the frequency error.

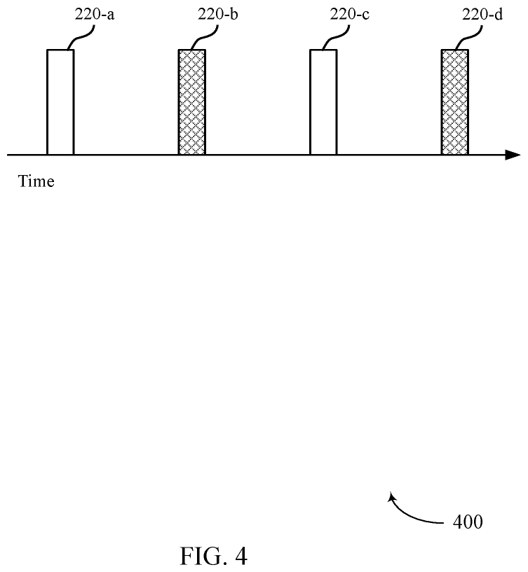

FIG. 4 illustrates an example of a timing diagram 400 that supports modem performance optimization under high frequency drift in accordance with one or more aspects of the present disclosure. The timing diagram 400 may implement aspects of or may be implemented by aspects of the wireless communications system 100.

As described herein, in a frequency error response configuration the UE 115 may increase the periodicity of monitoring for SSBs 220 to better track and correct for frequency error. SSBs may be used by a UE 115 to estimate frequency error. In normal operation, the UE 115 may not monitor all SSBs 220 transmitted by a network entity 105 in order to save power at the UE 115. For example, as shown in the timing diagram 400, in normal operation, the UE 115 may monitor the SSB 220-a and the SSB 220-c, but may not monitor for the SSB 220-b and the SSB 220-d. For example, the SSBs 220 may be transmitted by the network entity 105 at a periodicity of 5 ms, but the UE 115 may monitor for SSBs 220 at a periodicity of 10 ms in normal operation. Upon detection of high frequency drift, however, the UE 115 may increase the periodicity of SSB or TRS monitoring in accordance with the frequency error response configuration. With a higher SSB monitoring periodicity, the UE 115 may more frequently correct for frequency drift, and accordingly frequency error has less time to accumulate. For example, the UE 115 may monitor each of the SSB 220-a, the SSB 220-b, the SSB 220-c, and the SSB 220-d when operating in the frequency error response configuration.

In some examples, the UE 115 may use TRSs to estimate frequency error. In normal operation, the UE 115 may not monitor all TRSs transmitted by a network entity 105 in order to save power at the UE 115, similarly to how the UE 115 may not monitor all SSBs transmitted by the network entity. Upon detection of high frequency drift, however, the UE 115 may increase the periodicity of TRS monitoring in accordance with the frequency error response configuration. With a higher TRS monitoring periodicity, the UE 115 may more frequently correct for frequency drift, and accordingly frequency error has less time to accumulate.

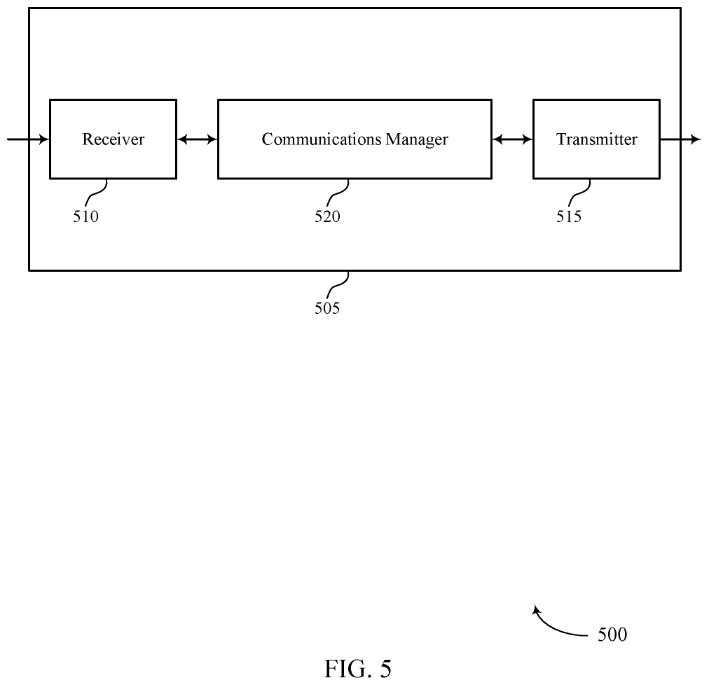

FIG. 5 illustrates a block diagram 500 of a device 505 that supports modem performance optimization under high frequency drift in accordance with one or more aspects of the present disclosure. The device 505 may be an example of aspects of a UE 115 as described herein. The device 505 may include a receiver 510, a transmitter 515, and a communications manager 520. The device 505 may also include one or more processors, memory coupled with the one or more processors, and instructions stored in the memory that are executable by the one or more processors to enable the one or more processors to perform the modem performance optimization under high frequency drift features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to modem performance optimization under high frequency drift). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to modem performance optimization under high frequency drift). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of modem performance optimization under high frequency drift as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for identifying frequency drift at the UE exceeds a threshold. The communications manager 520 may be configured as or otherwise support a means for operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

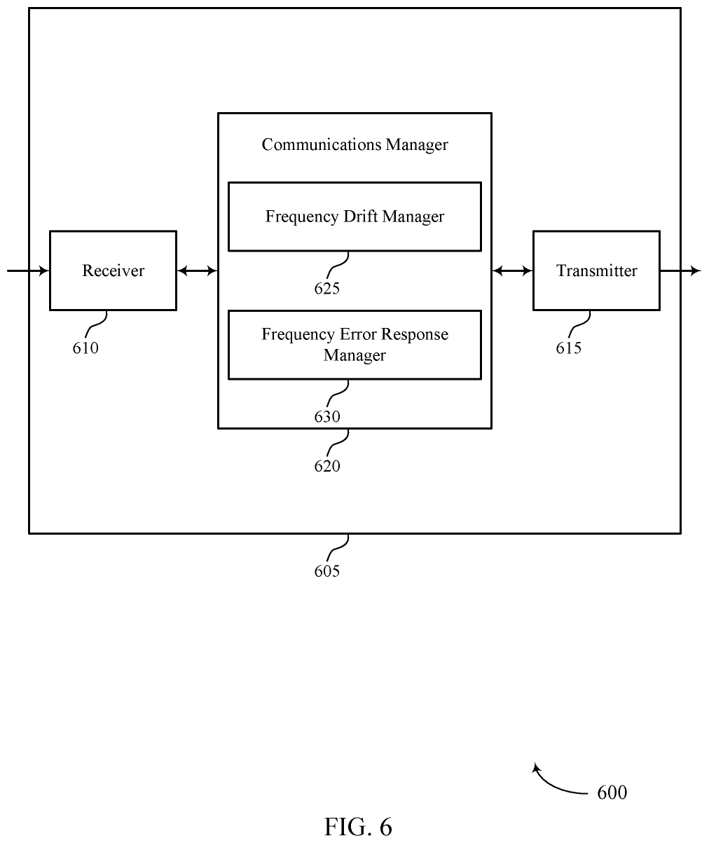

FIG. 6 illustrates a block diagram 600 of a device 605 that supports modem performance optimization under high frequency drift in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to modem performance optimization under high frequency drift). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to modem performance optimization under high frequency drift). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of modem performance optimization under high frequency drift as described herein. For example, the communications manager 620 may include a frequency drift manager 625 a frequency error response manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The frequency drift manager 625 may be configured as or otherwise support a means for identifying frequency drift at the UE exceeds a threshold. The frequency error response manager 630 may be configured as or otherwise support a means for operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

In some cases, the frequency drift manager 625 and the frequency error response manager 630 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the frequency drift manager 625 and the frequency error response manager 630 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

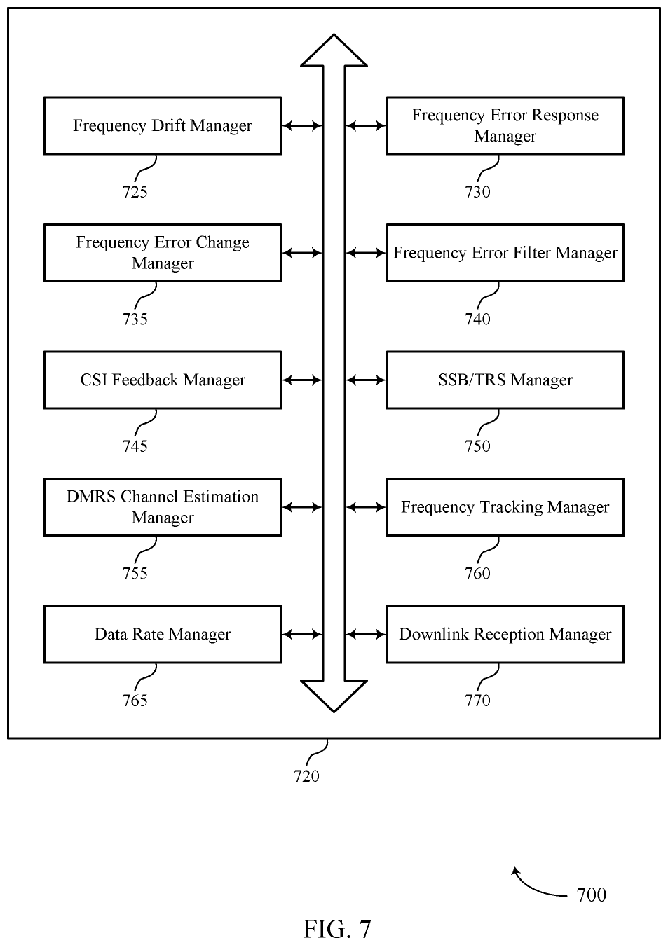

FIG. 7 illustrates a block diagram 700 of a communications manager 720 that supports modem performance optimization under high frequency drift in accordance with one or more aspects of the present disclosure. The communications manager 720 may be an example of aspects of a communications manager 520, a communications manager 620, or both, as described herein. The communications manager 720, or various components thereof, may be an example of means for performing various aspects of modem performance optimization under high frequency drift as described herein. For example, the communications manager 720 may include a frequency drift manager 725, a frequency error response manager 730, a frequency error change manager 735, a frequency error filter manager 740, a CSI Feedback Manager 745, an SSB/TRS manager 750, a DMRS channel estimation manager 755, a frequency tracking manager 760, a data rate manager 765, a downlink reception manager 770, or any combination thereof. Each of these components may communicate, directly or indirectly, with one another (e.g., via one or more buses).

The communications manager 720 may support wireless communications at a UE in accordance with examples as disclosed herein. The frequency drift manager 725 may be configured as or otherwise support a means for identifying frequency drift at the UE exceeds a threshold. The frequency error response manager 730 may be configured as or otherwise support a means for operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

In some examples, to support identifying the frequency drift at the UE exceeds the threshold, the frequency drift manager 725 may be configured as or otherwise support a means for identifying that the frequency drift output by a local oscillator of the UE exceeds the threshold.

In some examples, the threshold is based on one of a periodicity of synchronization signals blocks received at the UE or a periodicity of tracking reference signals received at the UE.

In some examples, to support identifying the frequency drift at the UE exceeds the threshold, the frequency error change manager 735 may be configured as or otherwise support a means for determining a change in frequency error between a first time and a second time. In some examples, to support identifying the frequency drift at the UE exceeds the threshold, the frequency error filter manager 740 may be configured as or otherwise support a means for filtering the change in frequency error between the first time and the second time to determine an instantaneous frequency drift, where the frequency drift is the instantaneous frequency drift.

In some examples, to support operating in accordance with the frequency error response configuration, the CSI Feedback Manager 745 may be configured as or otherwise support a means for operating in accordance with the frequency error response configuration including the adjustment to CSI feedback, where the adjustment to CSI feedback includes indicating a reduction in a data rate supported by the UE based on the frequency drift at the UE exceeding the threshold.

In some examples, the reduction in the data rate supported by the UE is based on a time offset between reception of a CSI-RS and one of a SSB or a tracking reference signal.

In some examples, the data rate manager 765 may be configured as or otherwise support a means for receiving a grant indicating a scheduled data rate for a message based on the reduction in the data rate supported by the UE. In some examples, the downlink reception manager 770 may be configured as or otherwise support a means for monitoring for the message based on the grant.

In some examples, to support operating in accordance with the frequency error response configuration, the SSB/TRS manager 750 may be configured as or otherwise support a means for operating in accordance with the frequency error response configuration including the adjustment to the periodicity of SSB or TRS monitoring, where the adjustment to the periodicity of SSB or TRS monitoring includes an increase in the periodicity of SSB or TRS monitoring.

In some examples, to support operating in accordance with the frequency error response configuration, the DMRS channel estimation manager 755 may be configured as or otherwise support a means for operating in accordance with the frequency error response configuration including use of the updated set of parameters for DMRS channel estimation, the updated set of parameters for DMRS channel estimation including at least one of a correction factor associated with a noise estimate to account for inter-carrier interference or a QCL parameter and time-domain interpolation filter to account for frequency error.

In some examples, to support operating in accordance with the frequency error response configuration, the frequency tracking manager 760 may be configured as or otherwise support a means for operating in accordance with the frequency error response configuration including use of the updated set of parameters for frequency tracking, the updated set of parameters for frequency tracking including at least one of a time-domain filter for estimating residual frequency error or an adjustment to tracking loop gain.

In some cases, the frequency drift manager 725, the frequency error response manager 730, the frequency error change manager 735, the frequency error filter manager 740, the CSI Feedback Manager 745, the SSB/TRS manager 750, the DMRS channel estimation manager 755, the frequency tracking manager 760, the data rate manager 765, and the downlink reception manager 770 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of [copy-paste in the independent and dependent claim modules within the communication manager] discussed herein

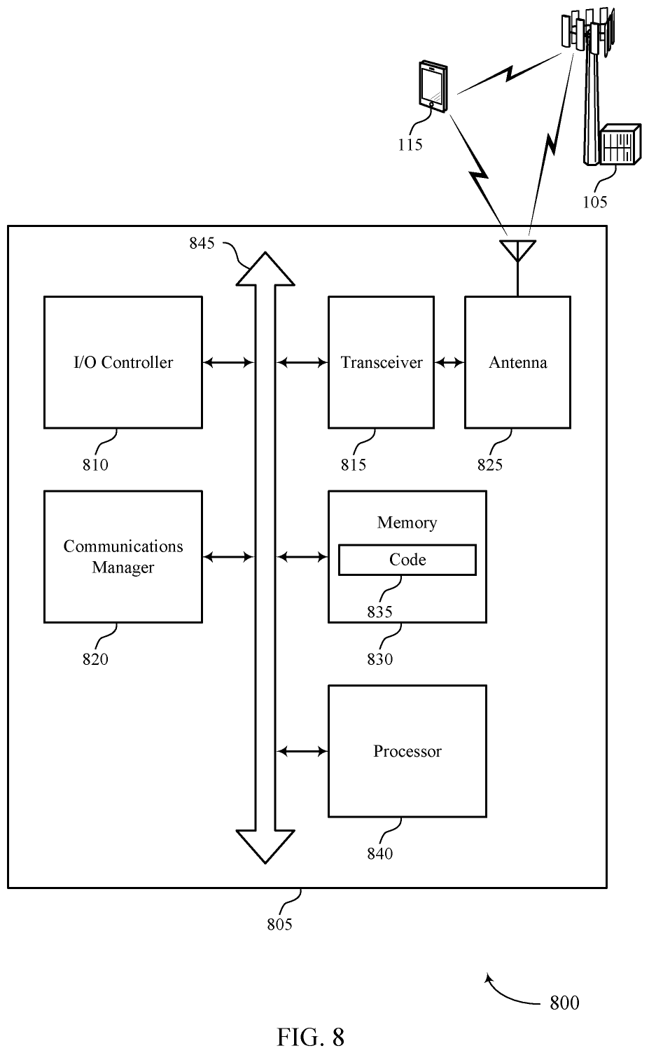

FIG. 8 illustrates a diagram of a system 800 including a device 805 that supports modem performance optimization under high frequency drift in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting modem performance optimization under high frequency drift). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for identifying frequency drift at the UE exceeds a threshold. The communications manager 820 may be configured as or otherwise support a means for operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking.

By including or configuring the communications manager 820 in accordance with examples as described herein, the device 805 may support techniques for improved communication reliability, improved user experience related to reduced processing, more efficient utilization of communication resources, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of modem performance optimization under high frequency drift as described herein, or the processor 840 and the memory 830 may be otherwise configured to perform or support such operations.

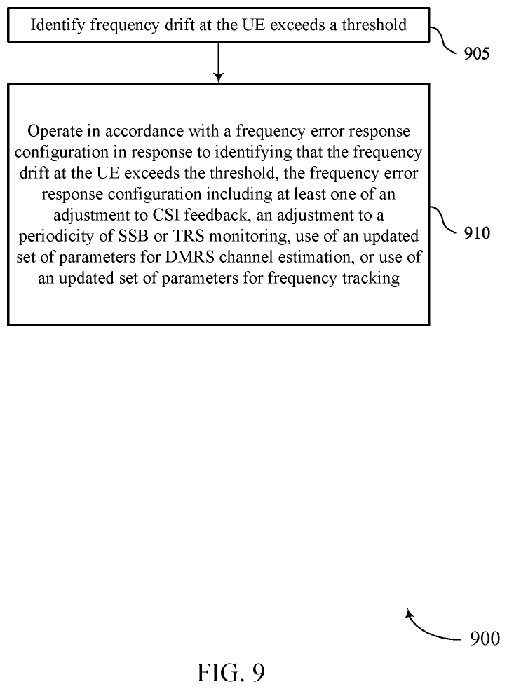

FIG. 9 illustrates a flowchart showing a method 900 that supports modem performance optimization under high frequency drift in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include identifying frequency drift at the UE exceeds a threshold. The operations of 905 may be performed in accordance with examples as disclosed herein. In some examples, aspects of the operations of 905 may be performed by a frequency drift manager 725 as described with reference to FIG. 7.

At 910, the method may include operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking. The operations of 910 may be performed in accordance with examples as disclosed herein. In some examples, aspects of the operations of 910 may be performed by a frequency error response manager 730 as described with reference to FIG. 7.

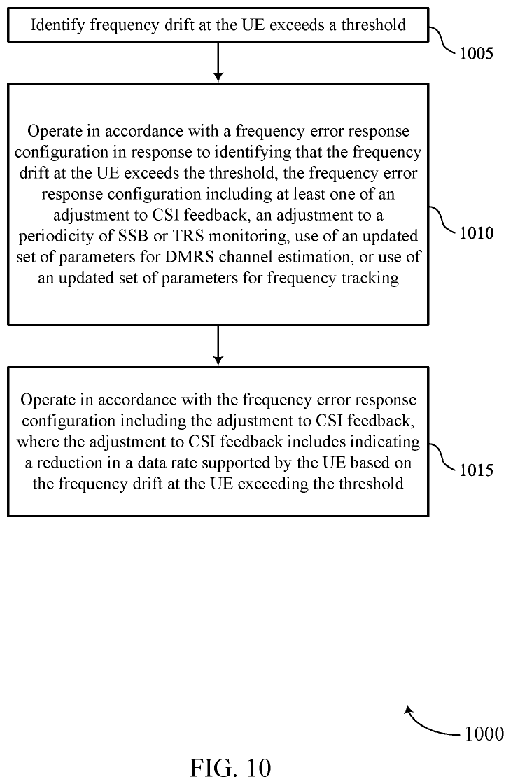

FIG. 10 illustrates a flowchart showing a method 1000 that supports modem performance optimization under high frequency drift in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include identifying frequency drift at the UE exceeds a threshold. The operations of 1005 may be performed in accordance with examples as disclosed herein. In some examples, aspects of the operations of 1005 may be performed by a frequency drift manager 725 as described with reference to FIG. 7.

At 1010, the method may include operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking. The operations of 1010 may be performed in accordance with examples as disclosed herein. In some examples, aspects of the operations of 1010 may be performed by a frequency error response manager 730 as described with reference to FIG. 7.

At 1015, the method may include operating in accordance with the frequency error response configuration including the adjustment to CSI feedback, where the adjustment to CSI feedback includes indicating a reduction in a data rate supported by the UE based on the frequency drift at the UE exceeding the threshold. The operations of 1015 may be performed in accordance with examples as disclosed herein. In some examples, aspects of the operations of 1015 may be performed by a CSI Feedback Manager 745 as described with reference to FIG. 7.

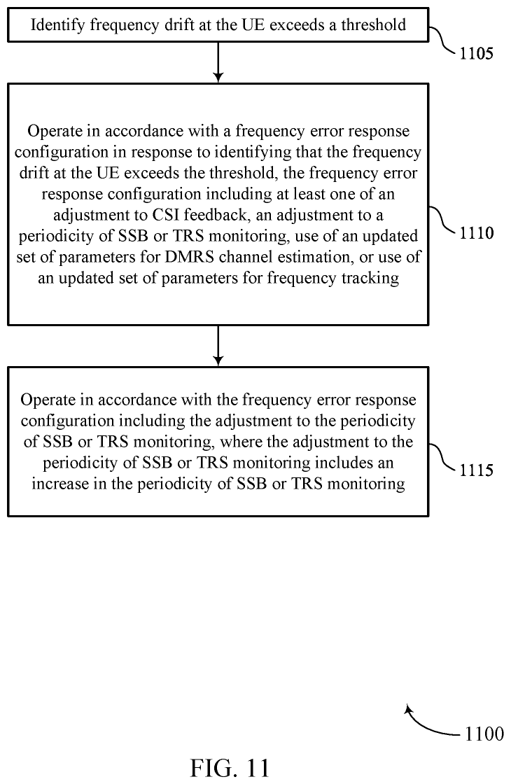

FIG. 11 illustrates a flowchart showing a method 1100 that supports modem performance optimization under high frequency drift in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include identifying frequency drift at the UE exceeds a threshold. The operations of 1105 may be performed in accordance with examples as disclosed herein. In some examples, aspects of the operations of 1105 may be performed by a frequency drift manager 725 as described with reference to FIG. 7.

At 1110, the method may include operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking. The operations of 1110 may be performed in accordance with examples as disclosed herein. In some examples, aspects of the operations of 1110 may be performed by a frequency error response manager 730 as described with reference to FIG. 7.

At 1115, the method may include operating in accordance with the frequency error response configuration including the adjustment to the periodicity of SSB or TRS monitoring, where the adjustment to the periodicity of SSB or TRS monitoring includes an increase in the periodicity of SSB or TRS monitoring. The operations of 1115 may be performed in accordance with examples as disclosed herein. In some examples, aspects of the operations of 1115 may be performed by an SSB/TRS manager 750 as described with reference to FIG. 7.

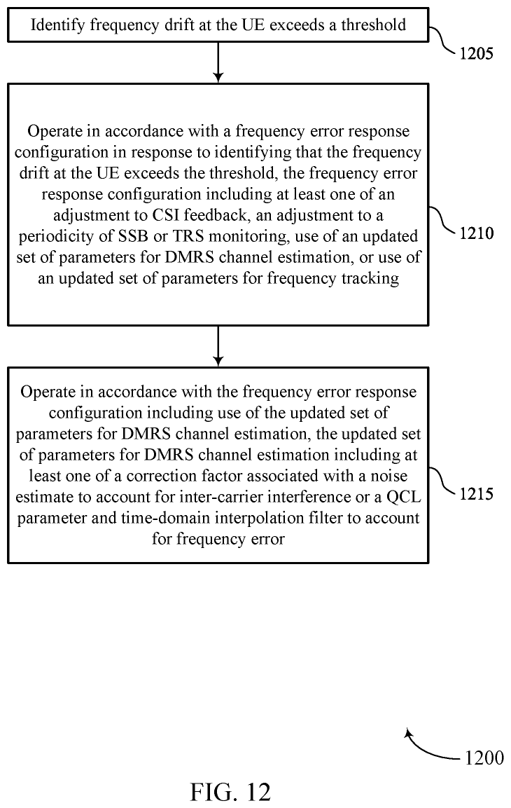

FIG. 12 illustrates a flowchart showing a method 1200 that supports modem performance optimization under high frequency drift in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include identifying frequency drift at the UE exceeds a threshold. The operations of 1205 may be performed in accordance with examples as disclosed herein. In some examples, aspects of the operations of 1205 may be performed by a frequency drift manager 725 as described with reference to FIG. 7.

At 1210, the method may include operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking. The operations of 1210 may be performed in accordance with examples as disclosed herein. In some examples, aspects of the operations of 1210 may be performed by a frequency error response manager 730 as described with reference to FIG. 7.

At 1215, the method may include operating in accordance with the frequency error response configuration including use of the updated set of parameters for DMRS channel estimation, the updated set of parameters for DMRS channel estimation including at least one of a correction factor associated with a noise estimate to account for inter-carrier interference or a QCL parameter and time-domain interpolation filter to account for frequency error. The operations of 1215 may be performed in accordance with examples as disclosed herein. In some examples, aspects of the operations of 1215 may be performed by a DMRS channel estimation manager 755 as described with reference to FIG. 7.

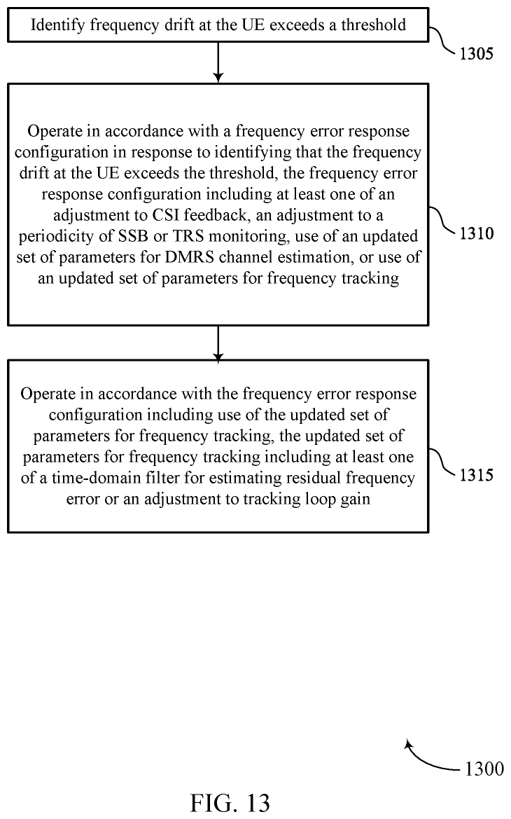

FIG. 13 illustrates a flowchart showing a method 1300 that supports modem performance optimization under high frequency drift in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include identifying frequency drift at the UE exceeds a threshold. The operations of 1305 may be performed in accordance with examples as disclosed herein. In some examples, aspects of the operations of 1305 may be performed by a frequency drift manager 725 as described with reference to FIG. 7.

At 1310, the method may include operating in accordance with a frequency error response configuration in response to identifying that the frequency drift at the UE exceeds the threshold, the frequency error response configuration including at least one of an adjustment to CSI feedback, an adjustment to a periodicity of SSB or TRS monitoring, use of an updated set of parameters for DMRS channel estimation, or use of an updated set of parameters for frequency tracking. The operations of 1310 may be performed in accordance with examples as disclosed herein. In some examples, aspects of the operations of 1310 may be performed by a frequency error response manager 730 as described with reference to FIG. 7.

At 1315, the method may include operating in accordance with the frequency error response configuration including use of the updated set of parameters for frequency tracking, the updated set of parameters for frequency tracking including at least one of a time-domain filter for estimating residual frequency error or an adjustment to tracking loop gain. The operations of 1315 may be performed in accordance with examples as disclosed herein. In some examples, aspects of the operations of 1315 may be performed by a frequency tracking manager 760 as described with reference to FIG. 7.

The following provides an overview of aspects of the present disclosure:

Aspect 1: A method for wireless communications at a UE, comprising: identifying frequency drift at the UE exceeds a threshold; and operating in accordance with a frequency error response configuration in response to identifying that the frequency drift at the UE exceeds the threshold, the frequency error response configuration comprising at least one of an adjustment to CSI feedback, an adjustment to a periodicity of SSB or TRS monitoring, use of an updated set of parameters for DMRS channel estimation, or use of an updated set of parameters for frequency tracking.

Aspect 2: The method of aspect 1, wherein identifying the frequency drift at the UE exceeds the threshold comprises: identifying that the frequency drift output by a local oscillator of the UE exceeds the threshold.

Aspect 3: The method of any of aspects 1 through 2, wherein the threshold is based at least in part on one of a periodicity of synchronization signals blocks received at the UE or a periodicity of tracking reference signals received at the UE.

Aspect 4: The method of any of aspects 1 through 3, wherein identifying the frequency drift at the UE exceeds the threshold comprises: determining a change in frequency error between a first time and a second time; and filtering the change in frequency error between the first time and the second time to determine an instantaneous frequency drift, wherein the frequency drift is the instantaneous frequency drift.

Aspect 5: The method of any of aspects 1 through 4, wherein operating in accordance with the frequency error response configuration comprises: operating in accordance with the frequency error response configuration comprising the adjustment to CSI feedback, wherein the adjustment to CSI feedback comprises indicating a reduction in a data rate supported by the UE based at least in part on the frequency drift at the UE exceeding the threshold.

Aspect 6: The method of aspect 5, wherein the reduction in the data rate supported by the UE is based at least in part on a time offset between reception of a CSI-RS and one of a SSB or a tracking reference signal.

Aspect 7: The method of any of aspects 5 through 6, further comprising: receiving a grant indicating a scheduled data rate for a message based at least in part on the reduction in the data rate supported by the UE; and monitoring for the message based at least in part on the grant.

Aspect 8: The method of any of aspects 1 through 7, wherein operating in accordance with the frequency error response configuration comprises: operating in accordance with the frequency error response configuration comprising the adjustment to the periodicity of SSB or TRS monitoring, wherein the adjustment to the periodicity of SSB or TRS monitoring comprises an increase in the periodicity of SSB or TRS monitoring.

Aspect 9: The method of any of aspects 1 through 8, wherein operating in accordance with the frequency error response configuration comprises: operating in accordance with the frequency error response configuration comprising use of the updated set of parameters for DMRS channel estimation, the updated set of parameters for DMRS channel estimation comprising at least one of a correction factor associated with a noise estimate to account for inter-carrier interference or a QCL parameter and time-domain interpolation filter to account for frequency error.

Aspect 10: The method of any of aspects 1 through 9, wherein operating in accordance with the frequency error response configuration comprises: operating in accordance with the frequency error response configuration comprising use of the updated set of parameters for frequency tracking, the updated set of parameters for frequency tracking comprising at least one of a time-domain filter for estimating residual frequency error or an adjustment to tracking loop gain.

Aspect 11: An apparatus for wireless communications at a UE, comprising a processor; memory coupled with the processor; and instructions stored in the memory and executable by the processor to cause the apparatus to perform a method of any of aspects 1 through 10.

Aspect 12: An apparatus for wireless communications at a UE, comprising at least one means for performing a method of any of aspects 1 through 10.

Aspect 13: A non-transitory computer-readable medium storing code for wireless communications at a UE, the code comprising instructions executable by a processor to perform a method of any of aspects 1 through 10.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more memories storing processor-executable code; and
one or more processors coupled with the one or more memories, wherein the one or more processors are individually or collectively configured to cause the apparatus to:
identify frequency drift at the UE exceeds a threshold; and
operate in accordance with a frequency error response configuration in response to identifying that the frequency drift at the UE exceeds the threshold, the frequency error response configuration comprising at least one of an adjustment to channel state information feedback, an adjustment to a periodicity of synchronization signal block or tracking reference signal monitoring, use of an updated set of parameters for demodulation reference signal channel estimation, or use of an updated set of parameters for frequency tracking.

2. The apparatus of claim 1, wherein the one or more processors are individually or collectively configured to cause the apparatus to identify the frequency drift at the UE exceeds the threshold by being individually or collectively configured to cause the apparatus to:
identify that the frequency drift output by a local oscillator of the UE exceeds the threshold.

3. The apparatus of claim 1, wherein the threshold is based at least in part on one of a periodicity of synchronization signals blocks received at the UE or a periodicity of tracking reference signals received at the UE.

4. The apparatus of claim 1, wherein the one or more processors are individually or collectively configured to cause the apparatus to identify the frequency drift at the UE exceeds the threshold by being individually or collectively configured to cause the apparatus to:
determine a change in frequency error between a first time and a second time; and
filter the change in frequency error between the first time and the second time to determine an instantaneous frequency drift, wherein the frequency drift is the instantaneous frequency drift.

5. The apparatus of claim 1, wherein the one or more processors are individually or collectively configured to cause the apparatus to operate in accordance with the frequency error response configuration by being individually or collectively configured to cause the apparatus to:
operate in accordance with the frequency error response configuration comprising the adjustment to channel state information feedback, wherein the adjustment to channel state information feedback comprises indicating a reduction in a data rate supported by the UE based at least in part on the frequency drift at the UE exceeding the threshold.

6. The apparatus of claim 5, wherein the reduction in the data rate supported by the UE is based at least in part on a time offset between reception of a channel state information reference signal and one of a synchronization signal block or a tracking reference signal.

7. The apparatus of claim 5, wherein the one or more processors are individually or collectively further configured to cause the apparatus to:
receive a grant indicating a scheduled data rate for a message based at least in part on the reduction in the data rate supported by the UE; and
monitor for the message based at least in part on the grant.

8. The apparatus of claim 1, wherein the one or more processors are individually or collectively configured to cause the apparatus to operate in accordance with the frequency error response configuration by being individually or collectively configured to cause the apparatus to:
operate in accordance with the frequency error response configuration comprising the adjustment to the periodicity of synchronization signal block or tracking reference signal monitoring, wherein the adjustment to the periodicity of synchronization signal block or tracking reference signal monitoring comprises an increase in the periodicity of synchronization signal block or tracking reference signal monitoring.

9. The apparatus of claim 1, wherein the one or more processors are individually or collectively configured to cause the apparatus to operate in accordance with the frequency error response configuration by being individually or collectively configured to cause the apparatus to:
operate in accordance with the frequency error response configuration comprising use of the updated set of parameters for demodulation reference signal channel estimation, the updated set of parameters for demodulation reference signal channel estimation comprising at least one of a correction factor associated with a noise estimate to account for inter-carrier interference or a quasi co-location parameter and time-domain interpolation filter to account for frequency error.

10. The apparatus of claim 1, wherein the one or more processors are individually or collectively configured to cause the apparatus to operate in accordance with the frequency error response configuration by being executable by being individually or collectively configured to cause the apparatus to:
operate in accordance with the frequency error response configuration comprising use of the updated set of parameters for frequency tracking, the updated set of parameters for frequency tracking comprising at least one of a time-domain filter for estimating residual frequency error or an adjustment to tracking loop gain.

11. A method for wireless communications at a user equipment (UE), comprising:
identifying frequency drift at the UE exceeds a threshold; and
operating in accordance with a frequency error response configuration in response to identifying that the frequency drift at the UE exceeds the threshold, the frequency error response configuration comprising at least one of an adjustment to channel state information feedback, an adjustment to a periodicity of synchronization signal block or tracking reference signal monitoring, use of an updated set of parameters for demodulation reference signal channel estimation, or use of an updated set of parameters for frequency tracking.

12. The method of claim 11, wherein identifying the frequency drift at the UE exceeds the threshold comprises:
identifying that the frequency drift output by a local oscillator of the UE exceeds the threshold.

13. The method of claim 11, wherein the threshold is based at least in part on one of a periodicity of synchronization signals blocks received at the UE or a periodicity of tracking reference signals received at the UE.

14. The method of claim 11, wherein identifying the frequency drift at the UE exceeds the threshold comprises:
determining a change in frequency error between a first time and a second time; and
filtering the change in frequency error between the first time and the second time to determine an instantaneous frequency drift, wherein the frequency drift is the instantaneous frequency drift.

15. The method of claim 11, wherein operating in accordance with the frequency error response configuration comprises:
operating in accordance with the frequency error response configuration comprising the adjustment to channel state information feedback, wherein the adjustment to channel state information feedback comprises indicating a reduction in a data rate supported by the UE based at least in part on the frequency drift at the UE exceeding the threshold.

16. The method of claim 15, wherein the reduction in the data rate supported by the UE is based at least in part on a time offset between reception of a channel state information reference signal and one of a synchronization signal block or a tracking reference signal.

17. The method of claim 15, further comprising:
receiving a grant indicating a scheduled data rate for a message based at least in part on the reduction in the data rate supported by the UE; and
monitoring for the message based at least in part on the grant.

18. The method of claim 11, wherein operating in accordance with the frequency error response configuration comprises:
operating in accordance with the frequency error response configuration comprising the adjustment to the periodicity of synchronization signal block or tracking reference signal monitoring, wherein the adjustment to the periodicity of synchronization signal block or tracking reference signal monitoring comprises an increase in the periodicity of synchronization signal block or tracking reference signal monitoring.

19. The method of claim 11, wherein operating in accordance with the frequency error response configuration comprises:
operating in accordance with the frequency error response configuration comprising use of the updated set of parameters for demodulation reference signal channel estimation, the updated set of parameters for demodulation reference signal channel estimation comprising at least one of a correction factor associated with a noise estimate to account for inter-carrier interference or a quasi co-location parameter and time-domain interpolation filter to account for frequency error.

20. A non-transitory computer-readable medium storing code for wireless communications at a user equipment (UE), the code comprising instructions executable by a processor to:
identify frequency drift at the UE exceeds a threshold; and
operate in accordance with a frequency error response configuration in response to identifying that the frequency drift at the UE exceeds the threshold, the frequency error response configuration comprising at least one of an adjustment to channel state information feedback, an adjustment to a periodicity of synchronization signal block or tracking reference signal monitoring, use of an updated set of parameters for demodulation reference signal channel estimation, or use of an updated set of parameters for frequency tracking.
